(19) United States
(12) Patent Application Publication
(10) Pub. No.: US 2011/0051275 A1
(43) Pub. Date: Mar. 3, 2011

(54) COMPUTER SYSTEM, DISK STORAGE DEVICE AND METHOD OF CONTROLLING THE SAME

(75) Inventors: Jong-uk HA, Gyeonggi-do (KR); Kum-ho SHIN, Gyeonggi-do (KR)

(73) Assignee: SAMSUNG ELECTRONICS CO., LTD., Gyeonggi-Do (KR)

(21) Appl. No.: 12/830,611

(22) Filed: Jul. 6, 2010

(30) Foreign Application Priority Data
Aug. 25, 2009 (KR) 10-2009-0078818

(51) Int. Cl. G11B 5/09

(52) U.S. Cl. 360/48; G9B/5.033

(57) ABSTRACT

A computer system, a disk storage device and a method of controlling the same reads data by a reading size from a disk storage unit in which the data is stored according to a request of an application for reading data. The data is divided from the reading size into a size allocated by the application and stored in a memory region which the application accesses.

### CLAIM OF PRIORITY

This application claims the benefit of priority from Korean Patent Application No. 10-2009-0078818, filed on Aug. 25, 2009 in the Korean Intellectual Property Office, the disclosure of which is incorporated herein by reference.

### BACKGROUND OF THE INVENTION

1. Field of the Invention

The present invention relates to a computer system, a disk storage device and a method of controlling the same. More particularly, the present invention relates to a disk storage device which reads out a data by the sector, a computer system, and a method of controlling the same.

2. Description of the Related Art

A computer system, such as a desktop PC, laptop, notebook, tablet pad PC, etc., typically has a disk storage device, e.g., a hard disk drive, to store a mass data.

A disk storage device reads a data by the sector, and in the case of a hard disk drive (typical magnetic disk drive), a size of the sector (hereinafter, also referred to as “reading size”) may generally be 512 bytes.

Meanwhile, a partition table is provided in a boot sector of a disk storage device, and the operating system (OS) obtains information about a partition through the partition table to access a data stored in the disk storage device.

As a boot sector, Master Boot Record (MBR), which is widely used, uses a sector address of 32 bytes to allocate a storage space of a disk storage device. In this case, if the sector has a size of 512 bytes, a partition table can allocate a maximum storage capacity of the disk storage device of 2 terabytes.

In order to use a disk storage device with a storage capacity of over 2 terabytes, a new partition table standard, such as GUID partition table (GPT), may be used. However, in order to follow a new partition standard causes a difficulty in design in that BIOS, OS, etc., which are widely used, need considerable changing.

Further, a disk storage device, such as a conventional hard disk drive, has a sector size which is fixed when manufactured, and its changing method is not suggested.

### SUMMARY OF THE INVENTION

Accordingly, one or more exemplary embodiments of the present invention provide a computer system which enables use of a mass disk storage device without significant modification of the BIOS and OS, which are widely used, as well as a disk storage device, and a method of controlling the same.

Another exemplary aspect of the present invention is to provide a computer system which changes a sector size with restrictions, and which is a reading unit of a disk storage device, a disk storage device, and a method of controlling the same.

According to an exemplary aspect of the present invention, there is provided a method of controlling a computer system preferably comprising reading a data by a reading size from a disk storage unit in which the data is stored according to a request of an application for reading a data; and dividing the data of the reading size into a size allocated by the application and storing the data in a memory region which the application accesses.

The method further comprises, for example, storing the data read from the disk storage unit in a memory region of a BIOS, wherein the storing in the memory region which the application accesses preferably comprises dividing the data stored in the memory region of the BIOS into a size allocated by the application and reading; and storing the data read from the memory region of the BIOS in the memory region which the application accesses.

The method further comprises, for example storing the data read from the disk storage unit into a disk memory unit, wherein the storing in the memory region which the application accesses comprises dividing the data of the reading size stored in the disk memory unit into a size allocated by the application and reading; and storing the data read from the disk memory unit in the memory region which the application accesses.

The method further comprises, for example, determining the reading size of the data, wherein the reading comprises reading the data by the determined reading size.

The determining preferably comprises determining the reading size of the data according to an input from a user.

The determining further comprises displaying a UI (user interface) to receive an input regarding the reading size of the data from the user.

The determining also comprises determining the reading size of the data according to a setting status of a size setting unit set by the user.

According to another exemplary aspect of the present invention, there is provided a computer system includes a disk storage unit in which a data is stored; a memory unit which includes a memory region which an application accesses; and a controller which reads data by a reading size from the disk storage unit, divides the data of the reading size into a size allocated by the application, and stores in the memory region which the application accesses according to a request of the application for reading the data.

The memory unit further preferably includes a memory region of a BIOS, and the controller controls the memory unit to a BIOS storing the data read from the disk storage unit in the memory region of the BIOS, divides the data stored in the memory region of the BIOS into a size allocated by the application and reads, and stores in the memory region which the application accesses.

The computer system further preferably includes a disk memory unit, and the controller includes a disk controller for storing the data read from the disk storage unit in a disk memory unit, and for dividing the data stored in the disk memory unit into a size allocated by the application and reading; and a BIOS storing the data read from the disk memory unit in the memory region which the application accesses.

The controller determines the reading size of the data and reads the data according to the determined reading size.

The computer system further includes an input unit, wherein the controller determines the reading size of the data according to user input through the input unit.

The computer system further includes a display unit, wherein the controller displays a UI (user interface) to receive input about the reading size of the data from the user.

The computer system further includes a size setting unit set by a user, wherein the controller determines the reading size of the data according to a setting status of the size setting unit.

According to still another exemplary aspect of the present invention, there is provided a method of a computer system controlling a disk storage device that comprises reading data according to a reading size from a disk storage unit in which the data is stored according to a request of an application for reading data in the computer system; and dividing the data of the reading size read from the disk storage unit into a size allocated by the application and transmitting to the computer system.

According to even another exemplary of the present invention, there is provided a disk storage device includes a disk storage unit in which data is stored; a disk memory unit; and a disk controller which reads data according to a reading size from the disk storage unit to store in the disk memory unit, divides the data stored in the disk memory unit into a size allocated by the application to read, and transmits to the computer system according to a request of the application for reading the data.

### BRIEF DESCRIPTION OF THE DRAWINGS

The above and/or other exemplary aspects will become more apparent and readily appreciated by a person of ordinary skill in the art from the following description of the exemplary embodiments, taken in conjunction with the accompanying drawings, in which:

FIG. 1 illustrates a block diagram of a computer system according to a first exemplary embodiment of the present invention;

FIG. 2 is a flow chart illustrating an operation of the computer system according to the exemplary embodiment of the present invention;

FIG. 3 illustrates the operation of the computer system according to the exemplary embodiment of the present invention;

FIG. 4 illustrates a block diagram of a computer system according to a second exemplary embodiment of the present invention;

FIG. 5 is a flow chart illustrating an operation of the computer system according to the exemplary embodiment of the present invention;

FIG. 6 illustrates the operation of the computer system according to the exemplary embodiment of the present invention;

FIG. 7 illustrates a block diagram of a computer system according to a third exemplary embodiment of the present invention;

FIG. 8 is a flow chart illustrating an operation of the computer system according to the exemplary embodiment of the present invention;

FIG. 9 illustrates the operation of the computer system according to the exemplary embodiment of the present invention;

FIG. 10 illustrates a block diagram of a computer system according to a fourth exemplary embodiment of the present invention;

FIG. 11 is a flow chart illustrating an operation of the computer system according to the exemplary embodiment of the present invention;

FIG. 12 illustrates a block diagram of a computer system according to a fifth exemplary embodiment of the present invention; and

FIG. 13 is a flow chart illustrating an operation of the computer system according to the exemplary embodiment.

### DETAILED DESCRIPTION

Below, exemplary embodiments of the present invention will be described in detail with reference to accompanying drawings so as to be realized by a person having ordinary skill in the art. The exemplary embodiments may be embodied in various forms without being limited to the exemplary embodiments set forth herein. Descriptions of well-known structures and functions may be omitted for clarity when their inclusion might obscure appreciation of the subject matter of the present invention by a person of ordinary skill in the art. In addition, like reference numerals typically refer to like elements throughout.

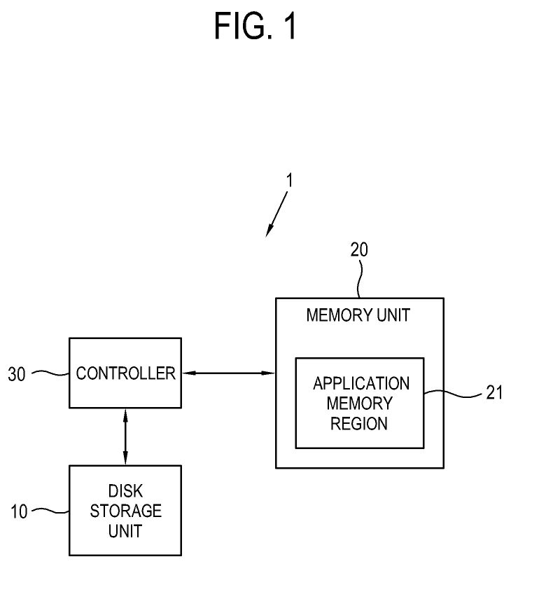

FIG. 1 illustrates a block diagram of a computer system according to first exemplary embodiment. As shown in FIG. 1, the computer system 1 may be realized, for example, as a desktop PC, a laptop, notebook, tablet pad, PC, etc. The computer system 1 according to the exemplary embodiment preferably includes a disk storage unit 10, a memory unit 20 and a controller 30.

The disk storage unit 10 comprises a device in which data is stored and may be provided as a disk storage device such as a hard disk drive (HDD). The memory unit 20 is a main memory and may be realized as random access memory (RAM). The memory unit 20 has an application memory region 21 in which a data for an application program (hereinafter, abbreviated to as “application”) is stored.

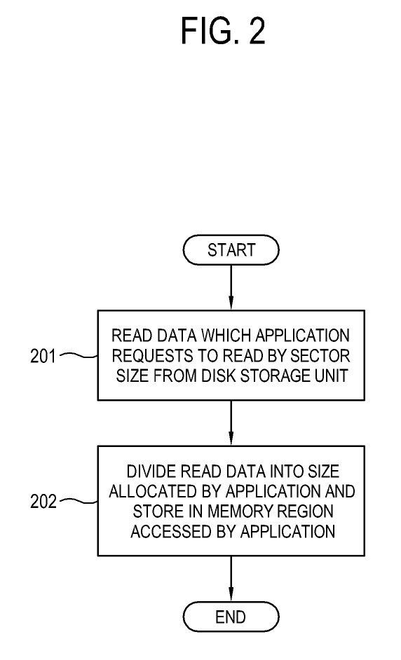

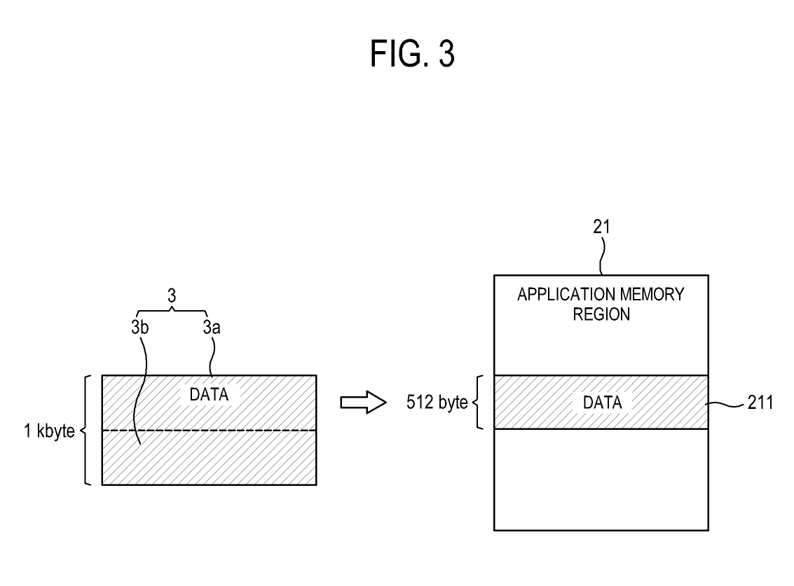

With continued reference to FIG. 1, the controller 30 executes a program to operate and performs a function according to the exemplary embodiment using a processor (typically a microprocessor) such as a CPU (not shown). A program corresponding to a function performed by the controller 30 of the exemplary embodiment preferably includes a BIOS and/or an OS. Such programs may be stored in an ROM (in the case of BIOS, not shown) or installed in an HDD (in the case of OS). The HDD where the OS is installed may be realized as the disk storage unit 10. The controller 30 according to the exemplary embodiment will be explained in detail with reference to FIGS. 2 and 3.

FIG. 2 is a flow chart illustrating an exemplary operation of the controller 30 according to the exemplary embodiment of the present invention.

First, at (201) the controller 30 reads out data by the reading size from the disk storage unit 10 according to a request of an application for data reading. Data stored in the disk storage unit 10 of the exemplary embodiment is read out by the sector. In this case, the reading size is a sector size. The controller 30 may read out data stored in the disk storage unit 10 by the sector with reference to a partition table provided in an MBR of the disk storage unit 10.

Next, at (s202) the controller 30 of the exemplary embodiment divides a data read in a sector size into a size allocated by the application and stores in the application memory region 21. An application of the exemplary embodiment allocates a memory with a capacity for a data to be accessed. If the size of the data read out is greater than the capacity of the memory allocated by the application, the controller 30 does not store the data at once but divides the data and stores in the application memory region 21.

FIG. 3 illustrates the operation of the controller 30 according to the exemplary embodiment of the present invention. With reference to FIG. 3, suppose that data 3 read out by the unit from the disk storage unit 10 has a size of 1 kilobyte, and a memory size allocated by the application is 512 bytes. The controller 30 of the exemplary embodiment stores a part of the read out data 3 of 512 bytes that is data 3a in an application memory region 211 in consideration of the memory size allocated by the application. Then, the controller 30 stores the other portion 3b of the data 3 in the application memory region 21 when the application accesses the data in the part 211.

Thus, in the computer system 1 according to the exemplary embodiment, an overflow which may occur when a unit of a data read out from the disk storage unit 10, i.e., a sector size, is greater than a memory size allocated by an application is prevented. Accordingly, a mass disk storage device may be used not according to a new standard of a partition table such as GPT, which involves a substantial change of BIOS or OS, but by only a simple modification in the design of software as in the presently claimed invention.

In the exemplary embodiment, since a sector size of the disk storage unit 10 is 1 kilobyte, which is twice as much as 512 bytes, the disk storage unit 10 has a maximum capacity of 4 terabytes. Alternatively, a sector size of the disk storage unit 10 may be 2 kilobytes and 4 kilobytes, and in this case the disk storage unit 10 has a maximum capacity of 8 terabytes and 16 terabytes, respectively. Likewise, in this case, the controller 30 of the exemplary embodiment may divide data of 2 kilobytes, 4 kilobytes, etc. read out from the disk storage unit 10 into 512 bytes, which is a memory size allocated by the application, and stored in the application memory region 21.

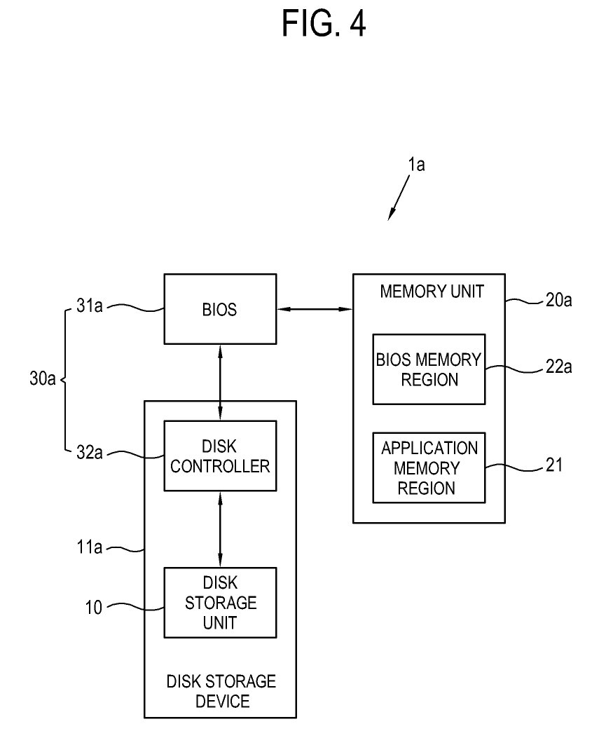

FIG. 4 illustrates a block diagram of a computer system 1a according to second exemplary embodiment of the present invention. The computer system 1a shown in FIG. 4 is not has many of the same or similar components to those in the computer system 1 shown in FIGS. 1 to 3, and its basic review of such components will not be repeated here. As shown in FIG. 4, the computer system 1a according to the exemplary embodiment includes a disk storage device 11a in which a disk storage unit 10 is provided, a memory unit 20a having an application memory region 21, and a controller 30a.

The disk storage device 11a of the exemplary embodiment may be realized as a hard disk drive. The controller 30a of the exemplary embodiment includes a BIOS 31a and a disk controller 32a. The BIOS 31a may be realized by a CPU (not shown) executing a BIOS program. The disk controller 32a is provided in the disk storage unit 11a and controls reading of data stored in the disk storage unit 10 according to a request of the BIOS 31a. Meanwhile, the memory unit 20a further includes a BIOS memory region 22a, which is a memory space for the BIOS 31a. In the exemplary embodiment, the computer system 1a may further include an input/output control hub (ICH, not shown) for interfacing between the BIOS 31a and the disk controller 32a.

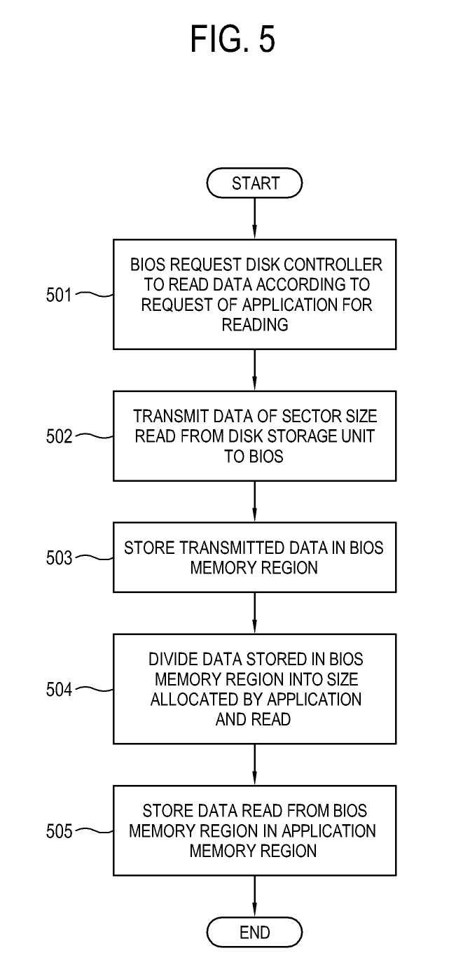

FIG. 5 is a flow chart illustrating exemplary operation of the computer system 1a shown in FIG. 4. First, at step (501), if an application requests reading of data stored in the disk storage unit 10, the BIOS 31a provides information about the data to the disk controller 32a and requests the reading.

According to the request of the BIOS 31a, at (502) the disk controller 32a reads out the data by the sector from the disk storage unit 10 and transmits a data with a sector size read out to the BIOS 31a. At (503) the data with the sector size is stored in the BIOS memory region 22a of the memory unit 20a.

Next, at (504) the BIOS 31a reads out the data with the sector size stored in the BIOS memory region 22a via dividing into a size allocated by the application and at (505) stores the read data in an application memory region 21a.

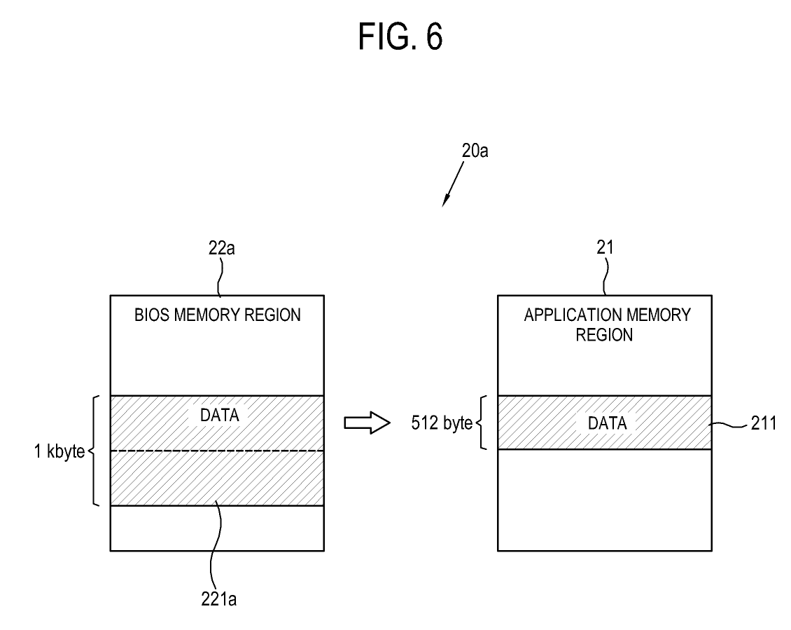

FIG. 6 illustrates the operation of the computer system 1a shown in FIGS. 4 and 5. In the exemplary embodiment, suppose that a size of data 3 read by the unit from the disk storage unit 10 is 1 kilobyte and a memory size allocated by an application is 512 bytes. As shown in FIG. 6, the BIOS 31a of the exemplary embodiment stores a part of 512 bytes 221a of the data stored in the BIOS memory region 22a in the application memory region 211 in consideration of the memory size allocated by the application. The operation of the BIOS 31a dividing and storing a data in the exemplary embodiment is similar to the operation by the controller 30 explained with reference to FIG. 4.

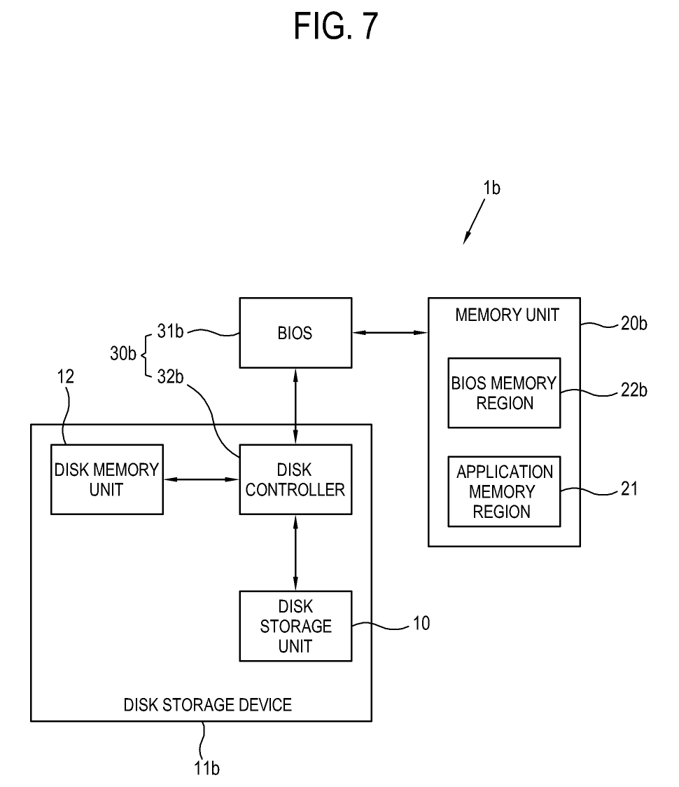

FIG. 7 illustrates a block diagram of a computer system 1b according to a third exemplary embodiment of the present invention. The computer system 1b shown in FIG. 7 has the same or similar components to those in the computer systems 1 and 1a shown in FIGS. 1 to 6. As shown in FIG. 7, the computer system 1b according to the exemplary embodiment includes a disk storage device 11b in which a disk storage unit 10 is provided, a memory unit 20b having an application memory region 21, and a controller 30b.

The disk storage device 11b of the exemplary embodiment may be realized as a hard disk drive. The controller 30b of the exemplary embodiment includes a BIOS 31b and a disk controller 32b. The BIOS 31b may be realized by a CPU (not shown) executing a BIOS program. The disk controller 32b is provided in the disk storage unit 11b and controls reading of a data stored in the disk storage unit 10 according to a request of the BIOS 31b. Meanwhile, the memory unit 20b further includes a BIOS memory region 22b which is a memory space for the BIOS 31b. In the exemplary embodiment, the computer system 1b may further include an input/output control hub (ICH, not shown) for interfacing between the BIOS 31b and the disk controller 32b. Further, the disk storage device 11b of the exemplary embodiment further includes a disk memory unit 12 which may be realized as an RAM and is a memory space for the disk controller 32b.

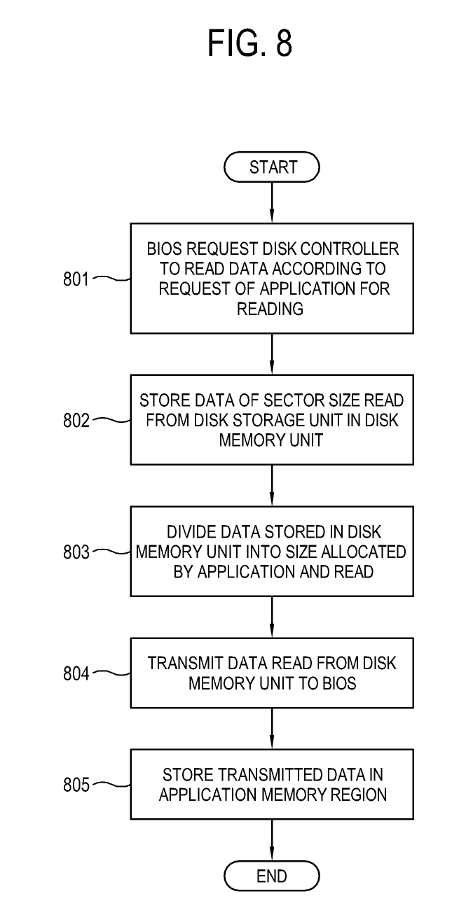

FIG. 8 is a flow chart illustrating an operation of the computer system 1b shown in FIG. 7. First, at step (801) if an application requests reading of a data stored in the disk storage unit 10, the BIOS 31b provides information about the data to the disk controller 32b and requests the reading.

According to the request of the BIOS 31b, the disk controller 32b reads out the data by the sector from the disk storage unit 10 and at step (802) stores a data with a sector size read out in the disk memory unit 12. At step (803) the disk controller 32b reads out the data by the sector size stored in the disk memory unit 12 via dividing into a size allocated by the application and at step (804) transmits a read data to the BIOS 31b. The transmitted data is stored in the BIOS memory region 22b of the memory unit 20b. Next, at step (805) the BIOS 31b stores the read data stored in the BIOS memory region 22b in an application memory region 21a.

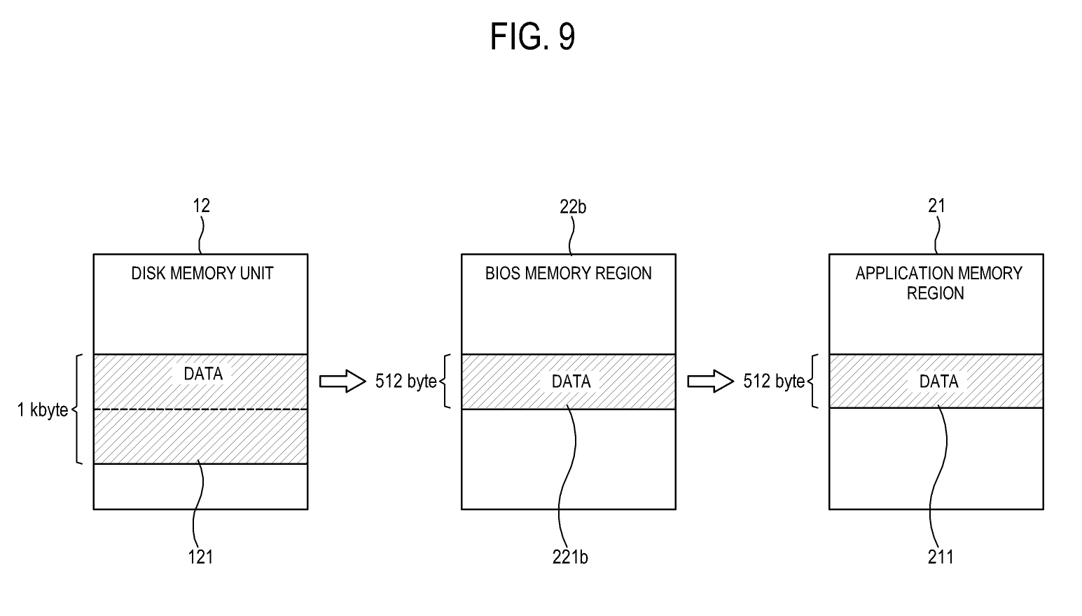

FIG. 9 illustrates the operation of the computer system 1b shown FIGS. 7 and 8. In the exemplary embodiment, suppose that a size of data 3 read by the unit from the disk storage unit 10 is 1 kilobyte and a memory size allocated by an application is 512 bytes. As shown in FIG. 9, the disk controller 32b of the exemplary embodiment stores a part of 512 bytes 121 of the data stored in the disk memory unit 12 in consideration of the memory size allocated by the application and transmits it to the BIOS 31b. The transmitted data is stored in the BIOS memory region 221b (in 22b), and then stored in the application memory region 211 (in 21a). The operation of the disk controller 32b dividing and storing a data in the present embodiment is similar to the aforementioned operations by the controller 30 and the BIOS 31a.

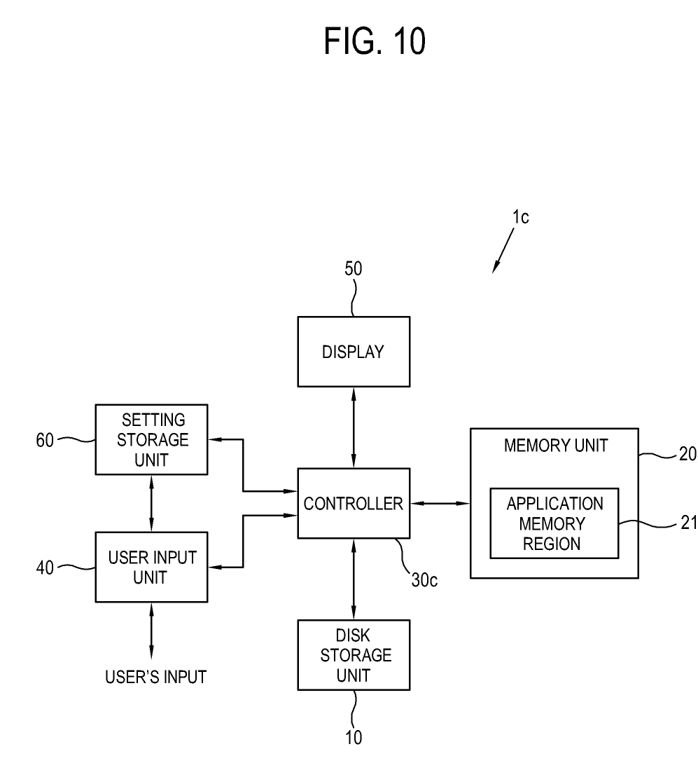

Hereinafter, a computer system according to another exemplary embodiment will be explained with reference to FIGS. 10 to 13. FIG. 10 illustrates a block diagram of the computer system 1c according to a fourth exemplary embodiment. The computer system 1c shown in FIG. 10 has the same or similar components to those in the computer systems 1, 1a and 1b shown in FIGS. 1 to 9 and is not repeated herein. As shown in FIG. 10, the computer system 1c according to the exemplary embodiment includes a disk storage unit 10, a memory unit 20, a user input unit 40, a display unit 50, a setting storage unit 60, and a controller 30c.

The user input unit 40 may be realized as a keyboard, a mouse, etc. and receives a user's input about the disk storage unit 10 setting a sector size. The display unit 50 may be realized as an LCD and displays a UI about setting a sector size according to control by the controller 30c. The setting storage unit 60 may be provided as a nonvolatile memory such as NVRAM and stores information about setting a sector size. The controller 30c may be provided as a CPU executing a BIOS program and performs an operation of setting a sector size of the disk storage unit 10 in addition to the operation of the aforementioned controller 30 dividing and storing a data. Moreover, the controller 30c of the exemplary embodiment may be realized as the controller 30a and 30b divided into the BIOS 31a and 31b and the disk controller 32a and 32b.

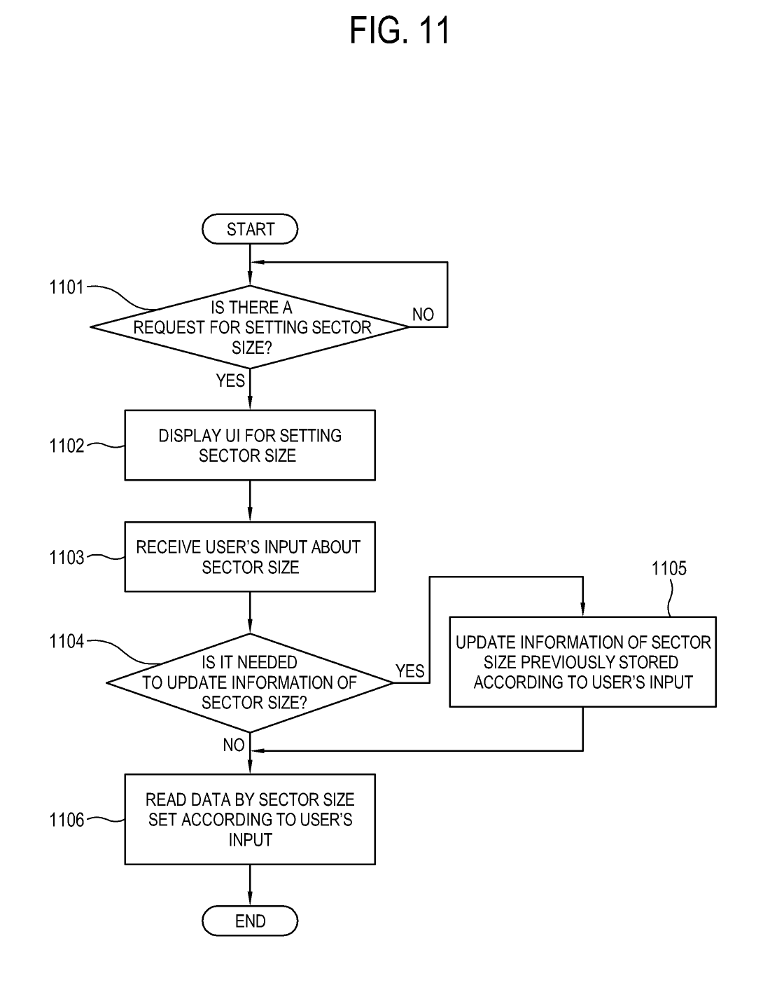

FIG. 11 is a flow chart illustrating an exemplary operation of the computer system 1c shown in FIG. 10. First, at (1101) the controller 30c identifies whether there is a request for setting a sector size of the disk storage unit 10 from a user through the user input unit 40. At step 1101, the controller 30c may, for example, determine whether there is a setting request when input with a key on a keyboard after booting up the computer system 1c.

If there is a request for setting a sector size of the disk storage unit 10 from the user, at step (1102) the controller 30c displays a UI for setting a sector size of the disk storage unit 10 on the display unit 50. Then, at step (1103) an input of the user about a sector size of the disk storage unit 10 is received through the user input unit 40. At steps 1102 and 1103, a predetermined sector size of the disk storage unit 10, e.g., 512 bytes, 1 kilobyte, 2 kilobytes, 4 kilobytes, etc., may be displayed to be selectable, and the user may select one of them.

Next, at step (1104) the controller 30c compares a setting of a sector size input from the user through the user input unit 40 with information regarding a sector size previously stored in the setting storage unit 60 and determines whether it is needed to update the information of the sector size. As a result, if it is necessary to update the pre-stored information of the sector size, at step (1105) the controller 30c updates the information of the sector size previously stored in the setting storage unit 60 to the input sector size.

If it is not needed to update the pre-stored information of the sector size at step 1104 or step 1105 is performed, at step (1106) the controller 30c reads out a data by the sector size set by user's input from the disk storage unit 10 according to a request of an application for reading a data. If the controller 30c of the exemplary embodiment is realized by dividing into a BIOS and a disk controller like the BIOS 31a and 31b and the disk controller 32a and 32b, which are explained with reference to FIGS. 4 to 9, the BIOS may transmit information about the sector size set by the user's input.

According to the exemplary embodiment, the sector size, which is a reading unit of the disk storage unit 10, may not be fixed but may be changed by user's input.

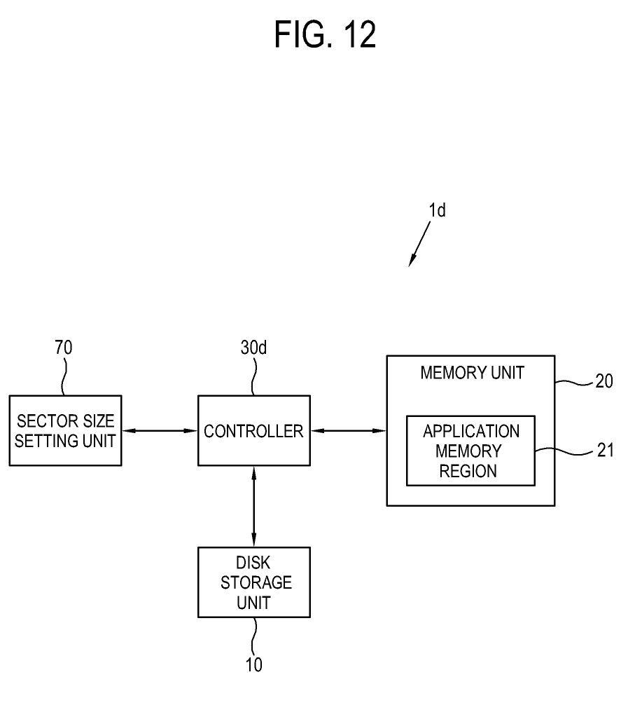

FIG. 12 illustrates a block diagram of a computer system 1d according to a fifth exemplary embodiment. The computer system 1d shown in FIG. 12 has the same or similar components to those in the computer systems 1, 1a, 1b and 1d shown in FIGS. 1 to 11 and is not repeated herein. As shown in FIG. 12, the computer system 1d according to the exemplary embodiment includes a disk storage unit 10, a memory unit 20, a sector size setting unit 70, and a controller 30d.

The sector size setting unit 70 may be changed in state by user's manipulation and is a means to set a sector size of the disk storage unit 10 with. The sector size setting unit 70 may, for example, be realized as a dip switch, a jumper switch, etc. and may be provided in a hard disk drive along with the disk storage unit 10. The sector size setting unit 70 has a status corresponding to 512 bytes, 1 kilobyte, 2 kilobytes, 4 kilobytes, etc. according to user's setting, and a setting status may be identified by the controller 30d.

The controller 30d may be realized as a single processor executing a BIOS program or the like or as two or more separate processors like the BIOS 31a and 31b and the disk controller 32a and 32b, which are explained with reference to FIGS. 4 to 9. The controller 30d performs an operation of changing a sector size of the disk storage unit 10 as well as the operation of the aforementioned controller 30 dividing and storing a data.

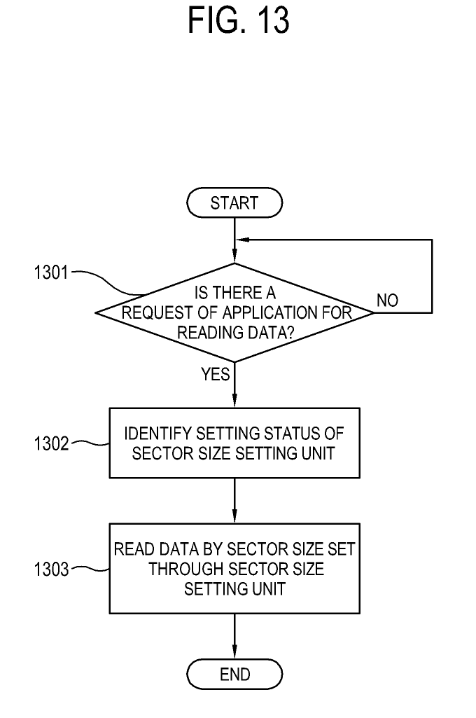

FIG. 13 is a flow chart illustrating an operation of the computer system 1d shown in FIG. 12. First, the controller 30d identifies whether there is a request of an application for reading a data (operation 1301). If there is a request of an application for reading a data, the controller 30d checks out a setting status of the sector size setting unit 70 (operation 1302). Then, the controller 30d reads out a corresponding data by the sector size set according to the setting status of the sector size setting unit 70 from the disk storage unit 10 (operation 1303).

According to the exemplary embodiment, the sector size, which is a reading unit of the disk storage unit 10, may not be fixed but may be changed by user's setting manipulation.

As described above, the present invention enables use of a mass disk storage device without modifying BIOS and OS much which are widely used.

Further, according to the present invention, a sector size, which is a reading unit of a disk storage device, may be changed unrestrictedly.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A method of controlling a computer system comprising:
reading data according to a reading size from a disk storage unit in which the data is stored in response to a request by an application for reading data; and
dividing the data from the reading size into a size allocated by the application and storing the size allocated data in a memory region which the application accesses.

2. The method according to claim 1, further comprising storing the data read from the disk storage unit in a memory region of a BIOS, and
wherein storing the size allocated data in the memory region which the application accesses comprises dividing the data stored in the memory region of the BIOS into a size allocated by the application and reading; and storing the data read from the memory region of the BIOS in the memory region which the application accesses.

3. The method according to claim 1, further comprising storing the data read from the disk storage unit in a disk memory unit,
wherein storing the size allocated data in the memory region which the application accesses comprises dividing the data of the reading size stored in the disk memory unit into a size allocated by the application and reading; and
storing the data read from the disk memory unit in the memory region which the application accesses.

4. The method according to claim 1, further comprising determining the reading size of the data,
wherein the reading comprises reading the data by the determined reading size.

5. The method according to claim 4, wherein the determining comprises determining the reading size of the data according to an input from a user.

6. The method according to claim 5, wherein the determining further comprises displaying a user interface (UI) to receive the input from the user about the reading size of the data.

7. The method according to claim 4, wherein the determining comprises determining the reading size of the data according to a setting status of a size setting unit set by the user.

8. A computer system including:
a disk storage unit in which data is stored;
a memory unit which includes a memory region which an application accesses; and
a controller which reads data according to a reading size from the disk storage unit, divides the data of the reading size into a size allocated by the application, and stores the size allocated data in the memory region which the application accesses according to a request of the application for reading the size allocated data.

9. The computer system according to claim 8, wherein the memory unit further includes a memory region of a BIOS, and the controller controls the memory unit to a BIOS storing the data read from the disk storage unit in the memory region of the BIOS, divides the data stored in the memory region of the BIOS into a size allocated by the application and reads, and stores the size allocated data in the memory region which the application accesses.

10. The computer system according to claim 8, further including a disk memory unit, and
the controller includes a disk controller storing the data read from the disk storage unit in a disk memory unit, and dividing the data stored in the disk memory unit into a size allocated by the application and reading; and a BIOS storing the data read from the disk memory unit in the memory region which the application accesses.

11. The computer system according to claim 8, wherein the controller determines the reading size of the data and reads the data according to the determined reading size.

12. The computer system according to claim 11, further including a user input unit,
wherein the controller determines the reading size of the data according to an input received from the user input unit.

13. The computer system according to claim 12, further including a display unit,
wherein the controller displays a user interface to receive input about the reading size of the data from the user input unit.

14. The computer system according to claim 11, further including a size setting unit having a setting status set by a user,
wherein the controller determines the reading size of the data according to a setting status of the size setting unit.

15. A method of a computer system controlling a disk storage device comprising:
reading a data according to a reading size from a disk storage unit in which the data is stored according to a request by an application for reading a data in the computer system; and
dividing the data from the reading size read from the disk storage unit into a size allocated by the application and transmitting the size allocated data to the computer system.

16. A disk storage device including:
a disk storage unit in which a data is stored;
a disk memory unit; and
a disk controller which reads a data according to a reading size from the disk storage unit to store in the disk memory unit, divides the data stored in the disk memory unit into a size allocated by the application to read, and transmits the size allocated data to the computer system according to a request by the application for reading the data.
